(19) United States
(12) Patent Application Publication
(10) Pub. No.: US 2004/0247897 A1
(43) Pub. Date: Dec. 9, 2004

(54) Sol solution for producing glass coatings for electrically conductive materials that can be used in anodic bonding

(76) Inventors: Hans-Joachim Quenzer, Itzehoe (DE); Arne Veit Schulz, Hamburg (DE)

Correspondence Address: VENABLE, BAETJER, HOWARD AND CIVILETTI, LLP, P.O. BOX 34385, WASHINGTON, DC, 20043-9998, US

(21) Appl. No.: 10/484,215

(22) PCT Filed: Jul. 11, 2002
(86) PCT No.: PCT/DE02/02541

(30) Foreign Application Priority Data
Jul. 18, 2001 (DE) 101 34 892.4
Feb. 28, 2002 (DE) 102 08 782.2

(51) Int. Cl. B32B 9/04; C01B 33/14

(52) U.S. Cl. 428/447; 516/81

(57) ABSTRACT

Disclosed is a sol solution and a method for producing this sol solution, which serves as a coating agent for producing glass coatings for electrically conductive materials that can be used in anodic bonding. The sol solution is a mix of an organosol consisting of SiO₂ dissolved in at least one n-alkanol or a mixture of a multiplicity of n-alkanols, a tetraethyl orthosilicate (TEOS) and/or a triethoxy silane or a trimethoxy silane as well as an acid or a base and water and the mixture being partially polymerized. The sol mixture is distinguished in that the mix contains an alkali alcoholate.

### TECHNICAL FIELD

The present invention relates to a sol solution for producing glass coatings for electrically conductive materials that can be used in anodic bonding. Furthermore, the present invention relates to a method for producing a sol solution acting as a coating agent as well as to the use thereof.

State of the Art

Anodic bonding refers to a method to produce a bond between alkaline glass and electrically conductive material. Such type bonding is suited, in particular, to bond two semiconductor elements, for example, two silicon wafers two-dimensionally with an alkaline glass layer lying between the two silicon wafers. Usually an electric voltage is applied between an ion-conductive glass and the silicon wafer at a temperature of 300-420° C. This electric voltage triggers electrochemcial reactions at the interface between the glass and the semiconductor which bond the glass firmly with the semi conductor. The result is a indissoluble bond between the alkaline glass and the semiconductor material. Especially suited for this anodic bonding of silicon wafers are, in particular, borosilicate glasses with a variable B₂O₃, SiO₂ and/or Al₂O₃ content. Such type borosilicate glasses are characterized by good chemical stability and a low expansion coefficient.

The glass layers required for anodic bonding are usually produced by molecular coating processes such as sputtering or vapor deposition or by coating with corresponding sol solutions. Thicker layers, as are needed in particular for bonding two silicon wafers, have process periods of a few hours if molecular coating methods are employed. Moreover, producing such layers in sputtering or vapor-deposition equipment always involves formation of equally thick coatings inside the devices. These coatings have to be removed from time to time, which means frequent maintenance and cleaning. As a consequence, application of glass layers by means of sputtering or vapor deposition for anodic bonding with intermediate glass layers is expensive and uneconomical.

In comparison, coating methods in which corresponding glass coatings are produced by means of spin-on deposition or immersion using corresponding sol solutions are quite economical as the devices employed in them are inexpensive and not very susceptible to failure. TEOS-based (tetraethyl orthosilicate) sol-gel coatings are used in these methods. However, when these coating methods are used to create thick glass layers, other disadvantages arise regarding the properties of the glass layers. For instance, in layer thicknesses as required in the anodic bonding of two semiconductor plates, mechanical tensions, which can lead to cracking, occur within the layers. For this reason, the conventionally used TEOS-based (tetraethyl orthosilicate) sol-gel coatings cannot be employed for producing layer thicknesses exceeding 100 nm.

In order to prevent such tensions, multiple layers are therefore applied on top of each other to produced thick glass layers for anodic bonding. However, even multiple applications of the layers and their subjection to thermal treatment does not usually permit exceeding layer thicknesses of 1000-1500 nm. Moreover, it has turned out that the obtainable layer quality, in particular regarding obtaining a faultless layer, becomes increasingly a problem the greater the number of applied layers. For this reason, the needed number of required coating procedures has to be kept to a minimum.

Thus, DE 196 03 023 A1 describes a process for anodic bonding and a method for producing glass layers for the purpose of anodic bonding and the suited sol solutions therefor. The described process is especially suited for anodic bonding with glass layers having a thickness of more than 100 nm up to 30 μm, which are also utilized for bonding two semiconductor layers. To produce the corresponding sol solution, a SiO₂ sol is dissolved in at least one n-alkanol or a mixture of a multiplicity of n-alkanols, n assuming a value between 1-5. Added to this organosol are then tetraethyl orthosilicate (TEOS) or methyl triethoxy silane (MTEOS) and water. Following this, an alcoholic alkaline salt solution is added to the sol in an acidic environment.

The alkaline salts employed for this are usually acetic acid salts. The disadvantage of using acetic acids is that it greatly reduces the lifetime of the solution. Experiments have shown that solutions to which the corresponding salts are added can be employed maximally for 30 minutes. A possible way of extending the lifetime of corresponding solutions is using salts, such as nitrates, that are easily soluble in alcohol. Employing such salts in the production of glass layers, however, leads to the formation of fine salt particles on the surface. Acetates could possibly be used to prevent such formation of small salt particles on the glass surface. In view of the attainable pH-values, the use of acetate, however, did not prove expedient.

To sum up, it can be said that there are fundamentally two prior art types of processes for producing glass layers having a thickness of between 0.5 and 30 μm (the typical layer thickness is from 4-5 μm), as is, for example, required for anodic bonding of two semiconductor plates. Molecular application methods such as sputtering or vapor deposition are unsuitable as they are expensive and entail expensive maintenance and cleaning. On the other hand, the more inexpensive processes, in which suited sol solutions are applied by spinning on or immersion, have shortcomings regarding the obtainable layer thickness and layer quality.

The object of the present invention is therefore to provide a suited sol solution that guarantees a substantially better lifetime of several days to weeks. Furthermore, with the aid of this solution, it should be possible to cost-effectively produce alkaline glass coatings for electrically conductive materials having a thickness of between 500 nm and 30 μm that can be used in anodic bonding.

### SUMMARY OF THE INVENTION

The solution to the object on which the present invention is based is set forth in claim 1. Furthermore, claim 6 puts forth a method for producing a sol solution acting as a coating material and claim 18 puts forth the use of the invented sol solution. Advantageous further improvements of the invented idea are the subject matter of the subclaims and are described in the following with reference to preferred embodiments.

According to the invention a sol solution for producing glass coatings for electrically conductive materials that can be used in anodic bonding which is a mix of an organosol consisting of SiO₂ dissolved in at least one n-alkanol or in a mixture of a multiplicity of n-alkanols, a tetraethyl orthosilicate (TEOS) and/or a triethoxy silane or a trimethoxy silane as well as an acid or a base and water and this mix is at least partially polymerized. The sol solution is distinguished in that the mix contains an alkali alcoholate.

For this purpose, the triethoxy silanes ethyl triethoxy silane, methyl triethoxy silane or vinyl triethoxy silane can be employed for producing the sol solution. As an alternative to the ethoxy silanes, the corresponding methoxy silanes can also be used.

In order to produce this sol solution, first a SiO₂ sol is produced in at least one n-alkanol or also in a mixture of a multiplicity of n-alkanols, with n assuming a value between 1 and 10. Tetraethyl orthosilicate and/or triethoxy silane are added to this organosol. The added triethoxy silane can be ethyl triethoxy silane, methyl triethoxy silane, vinyl triethoxy silane or the corresponding methoxy silanes. The created mix can be polymerized either in an acidic environment of pH 2-3 or in a basic environment of pH 9-11. Added to this mix is either water and a small amount of acid, or a base, such as for example an alkali alcoholate, is added before adding the water. In both cases, the solution is polymerized over a long period of time (polycondensation). The reaction of the components can be aided by gentle heating. If an alkali alcoholate is already added to the mixture in this process step, it is recommended to set the alkali content required later in the glass by adding the corresponding amount of alcoholate.

If, on the other hand, the polymerization is carried out in the acidic pH range, the amount of alkali oxide desired for the required glass composition can then be added in the form of an alkali alcoholate, preferably an ethylate. Furthermore, a part of the mixture TEOS/MTEOS can again be added and under circumstances also be mixed with water.

Both the acid and the alkali alcoholate can also already be dissolved in a n-alkanol, with n assuming a value between 1 and 10.

The invented sol solution is an almost clear, opalescent solution that is very suited for coating. The yielded solution, which guarantees a lifetime of several days to weeks, can then be concentrated and is thus at disposal after filtration for use for coating purposes.

After successful concentration and filtration, the invented sol solution can be applied to the part to be coated in a state of the art manner, for example by immersion, spinning on, or spraying. This coating is dried and tempered at a temperature which is selected according to the desired properties of the glass layer. Carrying out this process once yields layer thicknesses of 1 to 2 μm. This process can be repeated multiple times in order to obtain greater thicknesses, for example 2-30 μm. Between the individual coating steps, the newly applied layer has always to be dried and tempered.

The alkaline glass layer created in this manner is largely free of cracks and is very suited for anodic bonding. In this way, two plane substrates of electrically conductive material, such as for example two silicon wafers, can be firmly, indissoluble bonded to one another by a glass layer produced using the invented sol solution. Another advantage of the invented sol solution is that the concentration of the alkali ions in the finished glass layer can be set by adding various amounts of alcoholates to the invented sol solution.

The concentration of the respective sol solution influences the to-be-produced thickness of the glass layer. If a thin glass layer is to be produced with one coating step, the sol solution can be diluted with n-alkanols before coating, with n again assuming a value between 1 to 10. On the other hand, if the sol solution is concentrated, the layer thickness of the individual coating can be increased. Advantageously, for dilution that n-alkanol is used that is the solvent of the sol solution.

Furthermore, the properties of the finished glass layer is strongly influenced by the temperature at which the applied and dried sol solution is tempered. If tempering is carried out at a temperature below 400° C., a large amount of organic material, e.g. methyl groups, remains in the finished glass. In this case, the finished glass is an organically modified silicate with additional alkali ions.

If, on the other hand, the glass is tempered at temperatures above 450° C., the glass layer is densified. Such tempering can occur, for example, in air or in oxygen.

If the tempering is carried out at temperatures above 650° C., a very dense glass layer is created which possesses an alkali content, for example a Na₂O content, which can be precisely determined in advance by adding corresponding amounts of alkali alcoholates to the sol solution. Such type dense glass layers are distinguished by their tensile strength and are resistant even to alkaline etching.

Anodic bonding is easily possible in particular with glass layers tempered at temperatures of at least 550° C.

Improvements respectively modification of the properties of the glass layer created by the invented use of the sol solution can be attained by adding other chemical compounds to the invented sol solution. Thus, for example, in order to improve the chemical stability and to adapt the expansion coefficient of the glass layer to the to-be-bonded materials, boric compounds such as boric acid and/or organic aluminum compounds can be added to the sol solution. This is possible, because addition of these substances does not impair the properties of the finished glass layer functionally important for the anodic bonding.

Furthermore, it turned out that instead of methyl triethoxy silane (MTEOS), ethyl triethoxy silane (ETEO) or vinyl triethoxy silane (VTEOS) can also be used to produce the sol solution. Fundamentally, methoxy silanes can also be employed instead of the corresponding ethoxy silanes.

### BRIEF DESCRIPTIONS OF THE INVENTION

The present invention is described by way of example in the following using preferred and particularly simple embodiments of the present invention without the intention of limiting the scope or spirit of the overall inventive idea.

### EXAMPLE 1

Starting with an aqueous solution of silicon dioxide particles with an average diameter of 7 nm, an ethanolic alcohol sol is produced. 35.6 g of methyl triethoxy silane and 11.5 g of tetraethyl orthosilicate are added to 120 g of this alcohol sol, whose pH-value lies at 2. Then 9 g of water are added under continuous stirring. Following this, the mixture is maintained at a temperature of 22° C. for 3 hours.

After these process steps, an alcoholate, preferably a potassium ethylate, is added to this sol. For this purpose, 3 g of potassium ethylate are added to the sol and after a short reaction period, 0.1-0.2 g of water are added. The entire mixture is then maintained at a temperature of 40° C. for another 2 hours.

Before using this sol solution to produce glass coatings for electrically conductive materials that are employed in anodic bonding, the sol solution is concentrated and filtered.

Then the coating created with the sol solution is tempered at temperatures above 450° C., which leads to further densification of the glass layer. The tempering results in further densification of the glass layer. In this case, a glass layer is yielded which contains a relatively large amount of organic materials, here methyl groups.

### EXAMPLE 2

The process described below is an alternative to the one mentioned in example 1. First an alcohol sol is produced with an aqueous solution of silicon dioxide particles with an average diameter of 7 nm and ethanol. 35.6 g of methyl triethoxy silane and 11.5 g of tetraethyl orthosilicate are added to 120 g of this alcohol sol. Then 3 g of potassium ethylate are added to the sol and after a short reaction period, 4-6 g of water are added. This mix is then maintained at a temperature of approximately 40° C. for another 2 hours. The polycondensation of the single components occurs at a pH-value of between 9-12. If required, a small amount of an acid, for example acetic acid, can be added in order to set the pH-value and to prevent the pH-value from rising too high.

Before applying this sol solution to the electron conductive material, the sol solution is first concentrated and filtered. Then the coating is dried and finally tempered at a temperature of 600-650° C. to obtain a very dense glass layer.

1. A sol solution for producing glass coatings for electrically conductive materials that can be used in anodic bonding, said sol solution being a mix of an organosol consisting of SiO₂ dissolved in at least one n-alkanol or a mixture of a multiplicity of n-alkanols, a tetraethyl orthosilicate (TEOS) and/or a triethoxy silane or a trimethoxy silane as well as an acid or a base and water, with the mixture being at least partially polymerized, wherein said mix contains an alkali alcoholate.

2. A sol solution according to claim 1, wherein said triethoxy silane is an ethyltriethoxy silane, a methyltriethoxy silane or a vinyl triethoxy silane.

3. A sol solution according to claim 1, wherein said trimethoxy silane is ethyltrimethoxy silane, methyltrimethoxy silane or vinyltrimethoxy silane.

4. A sol solution according to claim 1, wherein in said n-alkanol, n assumes a value between 1 and 10.

5. A sol solution according to claim 1, wherein said sol solution contains in addition boric acid and/or organic aluminum compounds.

6. A method for producing a sol solution, which acts as a coating agent, for producing glass coatings for electrically conductive materials which can be used in anodic bonding,
characterized by the following process steps:
production of an organosol by dissolving a SiO₂ sol in at least one n-alkanol or in a mixture of n-alkanols,
creation of a mix in which tetraethyl orthosilicate (TEOS) and/or triethoxy silane or trimethoxy silane are added to said organosol,
addition of an alkali alkoholate,
polymerization.

7. A method according to claim 6, wherein ethyl triethoxy silane, methyl triethoxy silane or vinyl triethoxy silane are utilized as said triethoxy silane.

8. A methods according to claim 6, wherein ethyl trimethoxy silane, methyl trimethoxy silane or vinyl trimethoxy silane are utilized as said trimethoxy silane.

9. A method according to claim 6, wherein an alkanol is utilized, in which n assumes a value between 1 and 10.

10. A methods according to claim 6, wherein during said polymerization heat is added.

11. A methods according to claim 6, wherein a desired alkali content is set by adding a suited amount of said alkali alcoholate.

12. A method according to claim 6, wherein an ethanolate is utilized as said alkali alcoholate.

13. A method according to claim 6, wherein by adding water and an acid to said mix, said polymerization is conducted in an acidic environment.

14. A method according to claim 13, wherein said acid is dosed in such a manner that said acidic environment has a pH-value of 2 to 3.

15. A method according to claim 13, wherein after said addition of said alkali alcoholate, tetraethyl orthosilicate (TEOS) and/or methyl triethoxy silane (MTEOS) are added.

16. A method according to claim 13, wherein after said addition of said alkali alcoholate, tetraethyl orthosilicate (TEOS) and/or methyl triethoxy silane (MTEOS) and water are added.

17. A method according to claim 6, wherein by adding water and a base to said mix, said polymerization is conducted in an alkaline environment.

18. A method according to claim 17, wherein said base is dosed in such a manner that said alkaline environment has a pH-value of 9 to 11.

19. A method according to claim 17, wherein an alkali alcoholate is utilized as said base.

20. Use of the sol solution according to claim 1 for producing a coating by application onto a substrate by means of immersion, spinning on and/or spraying.

21. The use according to claim 20 wherein said coating is dried and is tempered.

22. The use according to claim 21, wherein said coating is tempered at up to 400° C.

23. The use according to claim 21, wherein said coating is tempered in air or in oxygen at above 450° C.

24. The use according to claim 21, wherein said coating is tempered at above 650° C.

25. The use according to claim 20, wherein coatings having a thickness of 500 nm to 30 μm are produced.

26. The use according to claim 20, wherein for producing coatings which have a thickness greater than 2 μm, said sol solution is multiply applied, dried and tempered on said substrate.

27. The use according to claim 20, wherein said coating is an alkaline glass layer applied onto an electrically conductive substrate.

28. The use according to claim 27, wherein said glass layer is utilized as an intermediate layer for bonding two electrically conductive, planar substrates by means of anodic bonding.
